(19) United States
(12) Patent Application Publication
(10) Pub. No.: US 2006/0153198 A1
(43) Pub. Date: Jul. 13, 2006

(54) Systems and methods for uninterrupted communication sessions

(75) Inventor: Lovleen Chadha, San Diego, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/033,104

(22) Filed: Jan. 10, 2005

(51) Int. Cl. H04L 12/56

(52) U.S. Cl. 370/395.2

(57) ABSTRACT

In some embodiments, systems and methods for uninterrupted communication sessions include automatically detecting, at a first device associated with a first user, a second device associated with the first user, and creating, at the first device associated with the first user, a network connection between the first and second devices associated with the first user, wherein the first device associated with the first user is to operate in a first medium and the second device associated with the first user is to operate in a second medium. Some embodiments may further include conducting a communication session at the first device associated with the first user, wherein the communication session at the first device associated with the first user is conducted in the first medium. According to some embodiments, the communication session may be transferred to the second device associated with the first user, wherein the communication session at the second device associated with the first user is conducted in the second medium.

### TECHNICAL FIELD

The present disclosure relates generally to systems and methods for communication, and more particularly to systems and methods for providing uninterrupted communication sessions.

### BACKGROUND

Many types and configurations of communication devices are utilized to conduct communication sessions. One user may, for example, receive broadcast media via a portable radio device, while other users may engage in two-way voice communications using wireless telephones. Transferring a communication session from one device and/or one medium to another, however, typically requires a great deal of user involvement.

If the user of the portable radio device desires to continue receiving the broadcast media on another device, for example, the user must typically program the new device to receive the specified media (e.g., tune the new device to the appropriate radio station or channel). Similarly, if one or both of the wireless telephone users desire to continue the conversation using another device such as a Voice over Internet Protocol (VoIP) device, the new device must typically be separately activated and/or programmed (e.g., the telephone number of one of the users may need to be entered into the new device to initiate a new call). Further, if a user desires to transfer a communication session from one medium to another (e.g., transfer an Instant Messaging (IM) session to a voice session), an entirely new session in the new medium must typically be initiated manually be the user.

Accordingly, there is a need for systems and methods for improved communication, and particularly for providing uninterrupted communication sessions, that address these and other problems found in existing technologies.

### SUMMARY

Methods, systems, and computer program code are therefore presented for providing uninterrupted communication sessions.

According to some embodiments, systems, methods, and computer code are operable to automatically detect, at a first device associated with a first user, a second device associated with the first user, and create, at the first device associated with the first user, a network connection between the first and second devices associated with the first user, wherein the first device associated with the first user is to operate in a first medium and the second device associated with the first user is to operate in a second medium.

Embodiments may further be operable to conduct a communication session at the first device associated with the first user, wherein the communication session at the first device associated with the first user is conducted in the first medium. Embodiments may further be operable to transfer the communication session to the second device associated with the first user, wherein the communication session at the second device associated with the first user is conducted in the second medium.

With these and other advantages and features of embodiments that will become hereinafter apparent, embodiments may be more clearly understood by reference to the following detailed description, the appended claims and the drawings attached herein.

### BRIEF DESCRIPTION OF THE DRAWINGS

FIG. 1 is a block diagram of a communication system;

FIG. 2 is a block diagram of a system according to some embodiments;

FIG. 3 is a flowchart of a method according to some embodiments;

FIG. 4 is a block diagram of a system according to some embodiments;

FIG. 5 is a flowchart of a method according to some embodiments;

FIG. 6 is a diagram of an exemplary system according to some embodiments;

FIG. 7 is a diagram of an exemplary system according to some embodiments; and

FIG. 8 is a block diagram of a system according to some embodiments.

### DETAILED DESCRIPTION

Some embodiments herein are associated with “communication”. As used herein, the term “communication” may refer to any information, data, and/or signal that is provided, transmitted, received, and/or otherwise processed by an entity, and/or that is shared or exchanged between two or more people, devices, and/or other entities.

As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Some embodiments described herein are associated with a “communication session”. As used herein, the phrase “communication session” may refer to any instance and/or occurrence of a receipt, transmittal, exchange, and/or sharing of information associated with the communication between two or more parties and/or entities. A communication session may include, for example, an e-mail transmittal, receipt, and/or exchange, an Instant Messaging (IM) session, a voice call (e.g., over a Public Switched Telephone Network (PSTN), a cellular network, or VoIP), a file upload, download, and/or exchange, a receipt and/or transmittal of broadcast media, and/or any combination thereof. Communication sessions may include continuous, periodic, intermittent, and/or any other frequency of communication that is or becomes known or practicable.

Some embodiments described herein are associated with a “communication device” or a “network device”. As used herein, the terms “communication device” and “network device” may be used interchangeably and may generally refer to any device that can communicate via a network. Examples of communications or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem or a wireless phone. Communication and network devices may comprise one or more communication or network components, such as a Static Random Access Memory (SRAM) device or module, a network processor, and a network communication path, connection, port, or cable.

In addition, some embodiments are associated with a “network” or a “communication network”. As used herein, the terms “network” and “communication network” may be associated with the transmission of messages, packets, signals, and/or other forms of information between and/or within one or more network devices. By way of example, a network may be configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard that is or becomes known or practicable.

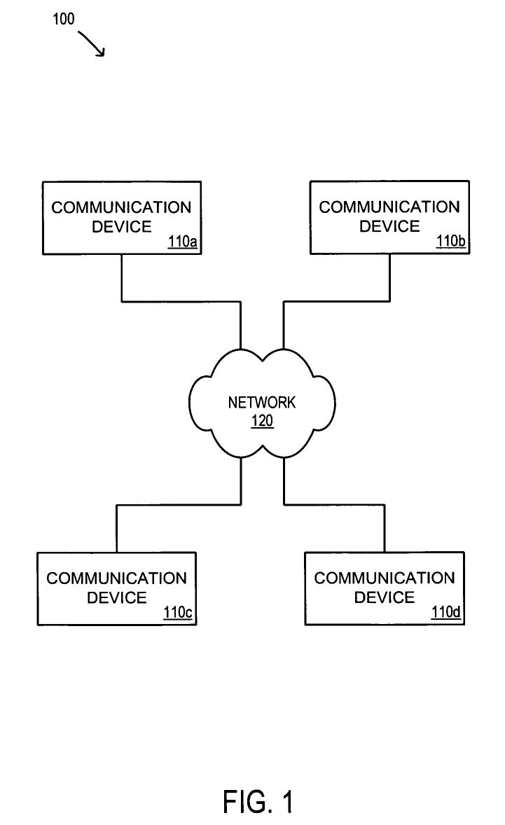

Referring first to FIG. 1, a block diagram of a communication system 100 is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may comprise, for example, one or more communication devices 110a-d that may communicate over a network 120. The communication devices 110a-d may be or include any quantity, type, and/or configuration of devices that are or become known or practicable. In some configurations, one or more of the communication devices 110a-d may be associated with one or more users (not shown in FIG. 1). A different user may, for example, be associated with each of the separate communication devices 110a-d. The various users may, for example, utilize their respective communication devices 110a-d to communicate with one or more of the other users over the network 120. In some configurations, the network 120 may include multiple networks associated with various types of communication mediums. The network 120 may include, for example, one or more Bluetooth®, PSTN, cellular, IP, and/or other wired or wireless networks or sub-networks. Communication sessions may be conducted between any or all of the communication devices 110a-d.

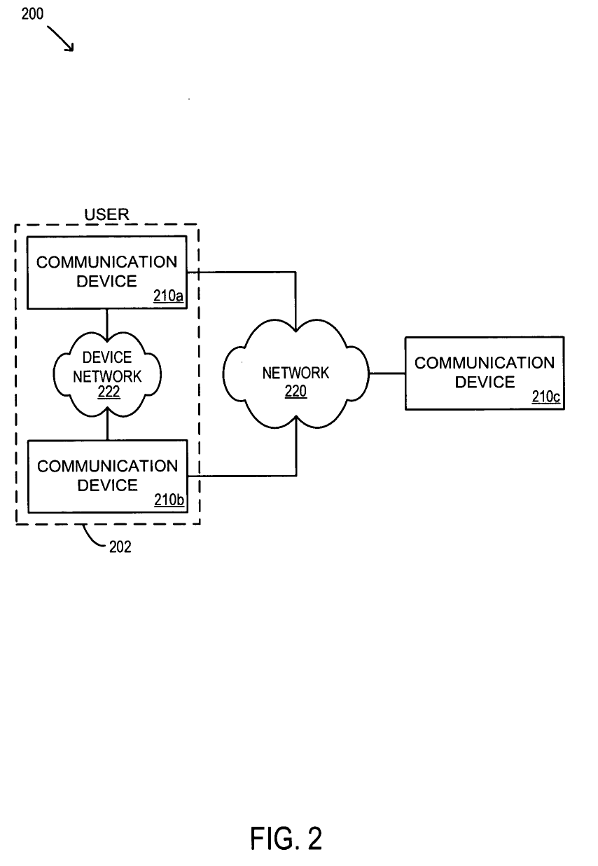

Referring in more detail to FIG. 2, a block diagram of a system 200 according to some embodiments is shown. The system 200 may include, according to some embodiments, a user 202, one or more communication devices 210a-c, a network 220, and/or a device network 222. Any communication device 210a-c may, according to some embodiments, be in communication with any other communication device 210a-c (e.g., via the network 220 and/or the device network 222). In some embodiments, the components 210, 220 of the system 200 may be similar in configuration and/or functionality to the similarly-named components described in conjunction with FIG. 1. In some embodiments, fewer or more components than are shown in FIG. 2 may be included in the system 200. In some embodiments, the communication devices 210a-c may be configured to communicate and/or otherwise receive and/or transmit information in one or more mediums. For example, the first communication device 210a associated with the user 202 may be configured to communicate via a first medium (e.g., voice), and/or the second communication device 210b associated with the user 202 may be configured to communicate via a second medium (e.g., text messaging). In some embodiments, the first communication device 210a associated with the user 202 may be utilized to establish a communication session (e.g., a cellular voice session) with the third communication device 210c. According to some embodiments, the third communication device 210c may be associated with a second user (not shown in FIG. 2).

For example, the third communication device 210c may be a cellular telephone associated with the second user. In some embodiments, the third communication device 210c may also or alternatively include a server such as a broadcast media server and/or other source of broadcast media and/or other information (e.g., a radio station, High Definition Television (HDTV) transmitter, a file server, and/or satellite). In some embodiments, the communication session between the first communication device 210a and the third communication device 210c may involve private, public, one-way, and/or two-way communication. The communication session may comprise, for example, receiving broadcast media from the third communication device 210c (e.g., a radio station) at the first communication device 210a (e.g., a radio receiver), or exchanging information (e.g., voice) between the first communication device 210a (e.g., a telephone) and the third communication device 210c (e.g., another telephone).

In some embodiments, the communication devices 210a-b associated with the user 202 may be coupled and/or otherwise in communication via a device network 222. According to some embodiments, the communication devices 210a-b associated with the user 202 may be capable of determining characteristics associated with the other communication devices 210a-b associated with the user 202. For example, the device network 222 may include a short-range and/or other wireless network such as a Bluetooth® network. In some embodiments, in the case that both communication devices 210a-b associated with the user 202 are powered on and/or activated, the first communication device 210a may be capable of detecting the presence of the second communication device 210b (and/or vice versa). Various information such as identification and/or configuration information may, for example, be automatically and/or otherwise shared between the communication devices 210a-b associated with the user 202.

According to some embodiments, the communication session between the first communication device 210a and the third communication device 210c may be transferred to the second communication device 210b. In some embodiments, an indication may be received and/or determined that is associated with a desire to transfer the communication session. The user 202 may, for example, provide input to the first communication device 210a to indicate that the communication session is to be transferred. According to some embodiments, the user 202 may utilize a Graphical User Interface (GUI), one or more buttons and/or soft keys, and/or voice commands to provide the indication. The user 202 may, for example, select the second communication device 210b from a list of available communication devices 210a-b associated with the user 202. In some embodiments, the indication may be otherwise determined and/or received. The first communication device 210a may, for example, determine a location of the first communication device 210a, which may be an indication associated with a desire to transfer the communication session.

According to some embodiments, in the case that the third communication device 210c provides broadcast and/or other media to the first communication device 210a, the second communication device 210b may be automatically set, tuned, and/or otherwise configured to receive the broadcast from the third communication device 210c. In some embodiments, such as in the case that the first communication device 210a and the second communication device 210b communicate in different mediums, the second communication device 210b may be configured to receive the broadcast in the appropriate medium. For example, the first communication device 210a may receive the broadcast via a particular radio station (e.g., a sound and/or voice medium), while the second communication device 210b may be a text-messaging device (e.g., that operates in text medium). In some embodiments, the first communication device 210a may (e.g., as part of transferring the communication session) provide the second communication device 210b with the appropriate text-messaging channel via which the same (and/or substantially the same) broadcast from the third communication device 210c may be received (e.g., a closed captioning and/or simulcast text feed associated with the broadcast may be received).

According to some embodiments, the first communication device 210a may query the third communication device 210c to determine various media types and/or associated properties via which the third communication device 210c may transmit the desired media. This and/or other information associated with the communication session (e.g., the broadcast and/or receipt thereof) may be provided and/or sent to the second communication device 210b to transfer the communication session. According to some embodiments, the second communication device 210b may be provided with identification and/or contact information associated with the third communication device 210c.

For example, in the case that the third communication device 210c is a telephone and/or a computer server, the second communication device 210b may be provided with the telephone number, IP address, and/or other identification and/or contact information associated with the third communication device 210c. In some embodiments, the first communication device 210a may, for example, store and/or have access to a list, file, cross reference, table, and/or other information that correlates parameters associated with different mediums with the communication session. The first communication device 210a may, for example, determine an IP address associated with a telephone number of the third communication device 210c (e.g., to facilitate text and/or other medium communications between the second communication device 210b and the third communication device 210c).

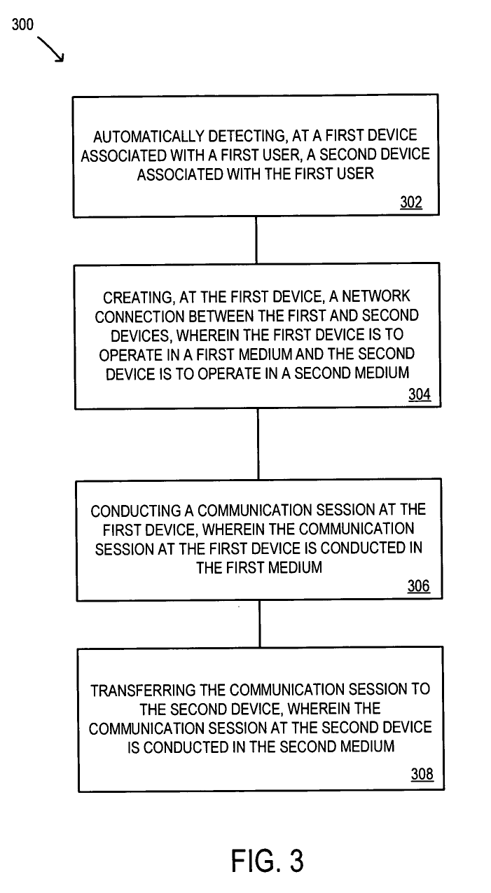

Turning now to FIG. 3, a method 300 according to some embodiments is shown. In some embodiments, the method 300 may be conducted by and/or by utilizing the systems 100, 200 and/or may be otherwise associated with the systems 100, 200 and/or any of the system components described in conjunction with any of FIG. 1 and/or FIG. 2. The method 300 may, for example, be performed by and/or otherwise associated with a communication device such as the first communication device 110a, 210a described herein. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 300 may begin at 302 by automatically detecting, at a first device associated with a first user, a second device associated with the first user. For example, the first and second devices (such as the first and second communication devices 110a-b, 210a-b) associated with the user may be capable of automatically detecting one another. According to some embodiments, the devices may include communication modules such as Bluetooth® modules that facilitate device discovery and/or communication. In some embodiments, a plurality of devices associated with a user may be capable of identifying, discovering, and/or communicating with one another.

According to some embodiments, any device associated with a user that is powered on and/or active may identify, locate, discover, and/or communicate with any other powered on and/or active device associated with the user. In the case that the user carries both a cellular telephone and a PDA device, for example, either or both devices may be and/or become “aware” of the presence of the other device. According to some embodiments, this awareness may include detecting the presence of the other device. In some embodiments, any powered on and/or active devices associated with the user may be configured to transmit identification signals that may, for example, be detected by other devices associated with the user.

The method 300 may continue, for example, at 304 by creating, at the first device associated with the first user, a network connection between the first and second devices associated with the first user, wherein the first device associated with the first user is to operate in a first medium and the second device associated with the first user is to operate in a second medium. In the case that Bluetooth® modules are utilized to allow and/or facilitate device detection, for example, the Bluetooth® modules may also be used to create, facilitate, and/or manage communications between the devices. In some embodiments, the network connection may be or include a Bluetooth® and/or other wireless or wired network (e.g., a device network 222).

According to some embodiments, the first device may detect the second device and may, for example, establish communications with the second device. In some embodiments, the first device may also or alternatively provide information to the second device. The first device may, for example, provide identification, configuration, and/or other information to the second device. According to some embodiments, any or all of the device communications and/or functions may be performed automatically. In other words, little or no user involvement may be necessary to establish communications and/or share information between devices associated with the user.

In some embodiments, the devices may communicate even if the devices are configured to operate in different mediums. Although the first device may communicate via a cellular network (e.g., a voice portion of the network 220) and the second device may communicate via a Public Switched Telephone Network (PSTN) (e.g., another voice portion of the network 220), the devices may be capable of detecting, identifying, and/or communicating with each other. The devices may, for example, communicate via a separate network such as the device network 222. In some embodiments, such a device network may be established in an ad-hoc, temporary, intermittent, and/or as-needed basis. In the case that the device network is a Bluetooth® network, for example, the communication and/or network connection between the devices may be established when the devices are powered on and/or activated, when the devices are within proximity of one another (e.g., within an operational range), and/or upon the occurrence of certain events (e.g., the receipt of an indication that a communication session is desired to be transferred from the first device to the second device).

According to some embodiments, the method 300 may continue at 306 by conducting a communication session, at the first device associated with the first user, wherein the communication session at the first device associated with the first user is conducted in the first medium. The first device may, for example, receive a broadcast, exchange information with one or more other devices, and/or otherwise be involved in a communication session (e.g., a communication session with a third device). In some embodiments, the communication session may be conducted in the first medium (e.g., voice). The first device may, for example, be a cellular telephone conducting involved in a voice call with another device.

The method 300 may continue, according to some embodiments, by transferring the communication session to the second device associated with the first user, wherein the communicator session at the second device associated with the first user is conducted in the second medium. The first device may, for example, transfer information associated with the communication session (e.g., conducted between the first device and a third device) to the second device. According to some embodiments, the transferred communication session may be conducted in the second medium.

Upon the receipt of an indication associated with communication session transfer, for example, the first device may provide the second device with information that allows the communication session to be automatically transferred to the second device. In the case that the first device is a PC communicating with a remote PC (e.g., a third device) via a text-based IM session and the second device is a wireless telephone (e.g., a voice device), for example, the first device may provide the second device with a telephone number associated with the remote PC. The telephone number may, according to some embodiments, include a telephone number capable of establishing a VoIP connection with the remote PC.

In some embodiments, the indication to transfer the communication session may be received from the user and/or may be otherwise determined. According to some embodiments, the first device may automatically transfer the communication session to the second device in the case that the first communication device is determined not to be a preferred device. In other words, the first device may detect and/or determine a condition (e.g., pre-defined by the user and/or another entity) that indicates that the communication session should be transferred. In the case that the battery power of the first device falls to a certain level and/or the first device is deactivated and/or powered off, for example, the first device may transfer the communication session to another device (e.g., the second device) to prevent a disruption in the communication session.

According to some embodiments, a change in location of either or both of the first and second devices may be an indication that the communication session should be transferred. In the case that the user desires to move to another location (e.g., a location away from a fixed-position first communication device and/or a location in which the first device may not operate and/or may not operate reliably), the first device may, for example, automatically search for, identify, and/or otherwise determine the second device. The communication session may then, according to some embodiments, be transferred to the second device. In such a manner, for example, the communication session may be continued without interruption even when the first device loses battery power, is moved outside of an operational and/or effective range, and/or is left or abandoned by the user.

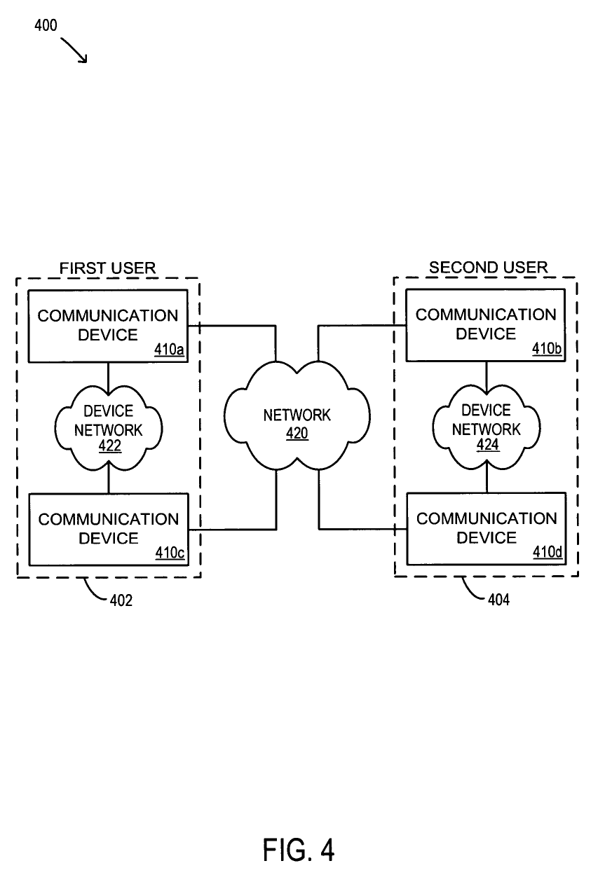

Turning now to FIG. 4, a block diagram of a system 400 according to some embodiments is shown. The system 400 may, for example, be associated with and/or may be similar to the systems 100, 200 described in conjunction with any of FIG. 1 and/or FIG. 2. In some embodiments, the system 400 may be utilized to conduct and/or implement the method 300 described herein (and/or processes thereof). The system 400 may include, according to some embodiments, one or more users 402, 404 (e.g., a first user 402 and a second user 404), one or more communication devices 410a-d, a network 420, and/or one or more device networks 422, 424. In some embodiments, the components 402, 410, 420, 422, 424 of the system 400 may be similar in configuration and/or functionality to the similarly-named components described in conjunction with any of FIG. 1 and/or FIG. 2. In some embodiments, fewer or more components than are shown in FIG. 4 may be included in the system 400.

In some embodiments, the first user 402 and the second user 404 may participate in a communication session utilizing the first communication device 410a and the second communication device 410b, respectively (e.g., communicating via the network 420). According to some embodiments, the first and second communication devices 410a-b may communicate and/or operate in a first medium. The first and second communication devices 410a-b may, for example, be PC devices that communicate through a text-based IM medium. In some embodiments, either or both of the first and second communication devices 410a-b may communicate with, identify, and/or detect other devices via the device networks 422, 424.

The first communication device 410a associated with the first user 402 may, for example, monitor, listen, search for, and/or otherwise detect a signal and/or other information that may be indicative of the presence of the third communication device 410c associated with the first user 402. Any communication device 410a, 410c associated with the first user 402 may, according to some embodiments, be capable of detecting other communication devices 410a, 410c associated with the first user 402. The first and third communication device 410a, 410c may, for example, include Bluetooth® modules that allow device detection and/or short-range wireless communication.

In some embodiments, the first user 402 may desire to transfer the communication session from the first communication device 410a to the third communication device 410c. The first user 402 may, for example, need to leave the first communication device 410a (e.g., such as a desktop PC and/or other substantially fixed location device), yet may still desire to continue the communication session with the second user 404 (e.g., without interruption and/or without substantial interaction required from the first user 402). In the case that the third communication device 410c is a mobile device, such as a wireless telephone, the first user 402 may, for example, transfer the communication session the third communication device 410c to continue the communication session while leaving and/or abandoning the first communication device 410a.

According to some embodiments, the first user 402 may press a button, select one or more menu and/or GUI options or items, and/or provide one or more pre-determined voice commands that provide an indication associated with the desire to transfer the communication session. In some embodiments, the first user 402 may specify that the communication session is to be transferred to the third communication device 410c (e.g., by picking the third communication device 410c from a list of devices that are available to conduct the communication session). In some embodiments, the first user 402 may not specify any particular device. In other words, the third communication device 410c may be automatically identified and/or selected (e.g., by the first communication device 410a).

For example, the first communication device 410a may search for, identify, and/or detect any or all other communication devices (such as the third communication device 410c) that are associated with the first user 402. The first communication device 410a may, upon receiving an indication that the communication session is desired to be transferred, for example, select one or more of the other communication devices to transfer the communication session to. The selection of one of the other communication devices may, according to some embodiments, be made based on various factors, such as selecting an alternate device having the most battery power, the best wireless reception, the largest memory, and/or that possesses other characteristics that are desirable for conducting the communication session. In the case that the third communication device 410c is the only other and/or wireless device available, for example, the first communication device 410a may automatically select the only available and/or viable option. In some embodiments, the first communication device 410a may notify the first user 402 in the case that transfer options are limited or in the case that no transfer options exist.

According to some embodiments, the communication session may be transferred only on the side of the first user 402. The third communication device 410c may, for example, continue the communication session with the second communication device 410b. In the case that the first and second communication devices 410a-b are text-based IM devices and the third communication device 410c is a wireless telephone having text-messaging capabilities, for example, the communication session may be continued in the same (e.g., first) medium. In some embodiments, such as in the case that the first communication device 410a is a cordless telephone, the second communication device 410b is a cellular telephone with text-messaging capabilities, and the third communication device 410c is a PC with IM capabilities, the communication session may be continued in a different medium. The communication session may initially be conducted via voice (between the first and second communication devices 410a-b), for example, and then continued between the second and third communication devices 410b-c via a text-based IM session.

In some embodiments, the communication session may be transferred on both the side of the first user 402 and the second user 404. In the case that the communication session is transferred from the first communication device 410a to the third communication device 410c, for example, the third communication device 410c may continue the communication session with the fourth communication device 410d. In the case that the first and second communication devices 410a-b are capable of communicating via the first medium and the third and fourth communication devices 410c-d are capable of communicating via the second medium, for example, the communication session may be continued in the second medium by transferring the communication session, to be conducted between the third and fourth communication devices 410c-d. In some embodiments, even if the third communication device 410c is capable of communicating with the second communication device 410b, either or both of the first and second users 402, 404 may desire that the communication session be transferred to both the third and fourth communication devices 410c-d.

According to some embodiments, the third communication device 410c may receive information from the first communication device 410a that facilitates the transfer of the communication session. The first communication device 410a may, for example, provide the IP address, telephone number, and/or other address or identification information associated with either or both of the second and fourth communication devices 410b, 410d, to the third communication device 410c. In some embodiments, the third communication device 410c may utilize the information to initiate communications with either (or both) of the second or fourth communication devices 410b, 410d.

The communication devices 410b, 410d associated with the second user 404 may also or alternatively communicate with one another via the device network 424. The second and fourth communication devices 410b, 410d may, for example, include Bluetooth® and/or other modules that allow the devices to identify, detect, and/or communicate with each other. In some embodiments, in the case that the first user transfers the communication session to the third communication device 410c, the first communication device 410a may provide an indication of the transfer to the second communication device 410b. The indication may include, for example, information identifying the third communication device 410c and/or the type and/or configuration of device that the communication session is to be transferred to. In some embodiments, the first communication device 410a may specify a device associated with the second user 404 that is desired, requested, suggested, and/or required to be utilized by the second user 404 to transfer the communication session. The first and second communication devices 410a-b may, for example, communicate and/or negotiate to determine alternate devices associated with one or both of the first or second users 402, 404 that may be appropriate and/or available to conduct the communication session.

According to some embodiments, such as in the case that the first communication device 410a notifies the second communication device 410b of the transfer to the third communication device 410c, the second communication device 410b may prepare for and/or otherwise facilitate the transfer. If the second communication device 410b is capable of and/or desirable for communicating with the third communication device 410c, for example, the second communication device 410b may set itself to automatically accept and/or otherwise prepare for a communication from the third communication device 410c. According to some embodiments, the second communication device 410b may also or alternatively notify the fourth communication device 410d of the transfer. In the case that the second communication device 410b is not capable and/or desirable for communicating with the third communication device 410c, for example, the second communication device 410b may alert the fourth communication device 410d (e.g., an appropriate and/or desirable communication device for the transfer).

The fourth communication device 410d may, according to some embodiments, be automatically set to accept the next incoming communication attempt and/or to automatically accept any and/or the next communication attempt from the third communication device 410c. In such embodiments, for example, neither the first user 402 nor the second user 404 may need to be substantially involved in transferring the communication session between the communication devices 410a-d. In other words, the transfer may be conducted in a substantially automated manner that relieves the users 402, 404 of the burden of being required to manually transfer the communication session and/or initiate a new communication session.

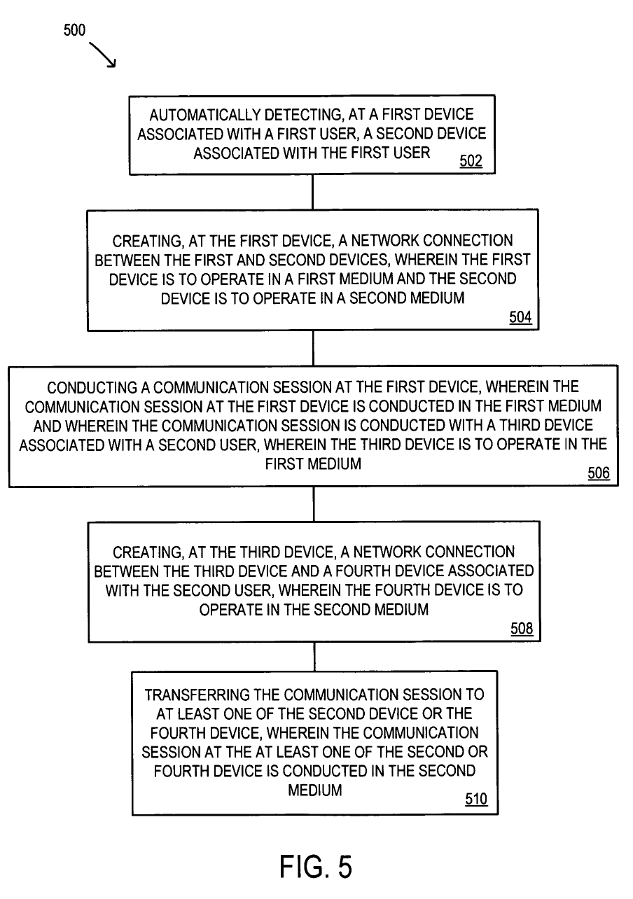

Referring now to FIG. 5, a method 500 according to some embodiments is shown. In some embodiments, the method 500 may be conducted by and/or by utilizing the systems 100, 200, 400 and/or may be otherwise associated with the systems 100, 200, 400 and/or any of the system components described in conjunction with any of FIG. 1, FIG. 2, and/or FIG. 4. The method 500 may, for example, be performed by and/or otherwise associated with any of the communication devices 10a-d, 210a-c, 410a-d described herein. In some embodiments, the method 500 may be similar to, integrated with, and/or otherwise related to the method 300 described herein.

In some embodiments, the method 500 may begin at 502 by automatically detecting, at a first device associated with a first user, a second device associated with the first user. According to some embodiments, the automatic detection at 502 may be similar to the automatic detection performed at 302 in the method 300. The first device may, for example, receive, search for, detect, and/or otherwise identify a signal associated with the presence of the second device. Other devices in addition to and/or instead of the second device may also or alternatively be detected by the first device. Any or all devices associated with the first user may, for example, be detected and/or otherwise identified. In some embodiments, the automatic detection may be initiated and/or caused by the first user and/or another entity (e.g., by pre-programming).

The method 500 may continue, according to some embodiments, at 504 by creating, at the first device associated with the first user, a network connection between the first and second devices associated with the first user, wherein the first device associated with the first user is to operate in a first medium and the second device associated with the first user is to operate in a second medium. According to some embodiments, the creating of the network connection at 504 may be similar to the network connection creation performed at 304 in the method 300. The first and second devices may, for example, be coupled and/or otherwise connected via any type and/or configuration of network that is or becomes known or practicable. In some embodiments, the devices may be connected via a device network such as a Bluetooth® network. The devices may share and/or exchange information via the device network substantially continuously, intermittently, and/or on an as-needed basis. In some embodiments, the device network may allow devices that operate in different mediums (e.g., that would otherwise be unable to communicate) to be coupled and/or otherwise communicate.

According to some embodiments, the method 500 may continue at 506 by conducting a communication session at the first device associated with the first user, wherein the communication session at the first device associated with the first user is conducted in the first medium and wherein the communication session is conducted with a third device associated with a second user, wherein the third device associated with the second user is to operate in the first medium. The first device may, for example, be utilized by the first user to communicate with the second user utilizing the third device. In some embodiments, either or both of the first device and the third device may also be capable of operating in one or more other mediums (e.g., in addition to the first medium). The third device may, for example, be a PC device that is capable of communicating via IM, VoIP, and/or other mediums.

The method 500 may continue at 508, for example, by creating, at the third device associated with the second user, a network connection between the third device associated with the second user and a fourth device associated with the second user, wherein the fourth device associated with the second user is to operate in the second medium. The creating of the network connection at 508 may, according to some embodiments, be similar to the network creation performed at 504. In some embodiments for example, a device network may be utilized on only one side of the communication session. Only devices associated with the first user may, for example, be capable of identifying, detecting, and/or communicating with each other. According to some embodiments, both sides of the communication session may utilize device networks.

For example, devices associated with the second user may also or alternatively be capable of identifying, detecting, and/or communicating with each other. In some embodiments, the device networks on both ends of the communication session may be compatible, capable of interconnection, and/or may be or include the same network and/or network components. Any or all devices (e.g., associated with either user) may, for example, include Bluetooth® modules. In some embodiments, any or all of the various devices may communicate via the device network and/or networks. According to some embodiments, the device network communication may occur in addition to and/or simultaneously with other device communications. Devices associated with different users may also or alternatively be capable of communicating via one or more device networks. In the case that two devices are cellular telephones that are Bluetooth® compliant, for example, the devices may communicate via the device network (e.g., Bluetooth®) while the users of the devices conduct a voice conversation over a Global System for Mobile (GSM) communications network

According to some embodiments, the method 500 may continue at 510 by transferring the communication session to at least one of the second device associated with the first user or the fourth device associated with the second user, wherein the communication session at the at least one of the second device associated with the first user or the fourth device associated with the second user is conducted in the second medium. The communication session may, for example, be transferred from the first device to the second device (e.g., on the first user's side of the communication session) and/or from the third device to the fourth device (e.g., on the second user's side of the communication session). In some embodiments, the first user may, for example, desire to utilize a different device and/or desire to communicate with the second user via a different medium.

The first device may not be the preferred device, according to some embodiments, and the communication session may accordingly be transferred to another device associated with the first user, such as the second device. In some embodiments, the second device associated with the first user may continue the communication session with the third device associated with the second user. According to some embodiments, the second device associated with the first user may also or alternatively continue the communication session with the fourth device associated with the second user. The communication session may be continued (e.g., after being transferred), according to some embodiments, in either or both of the first and second mediums. The communication session may, for example, be switched from the first medium to the second medium and/or may include a combination of the mediums (and/or other mediums).

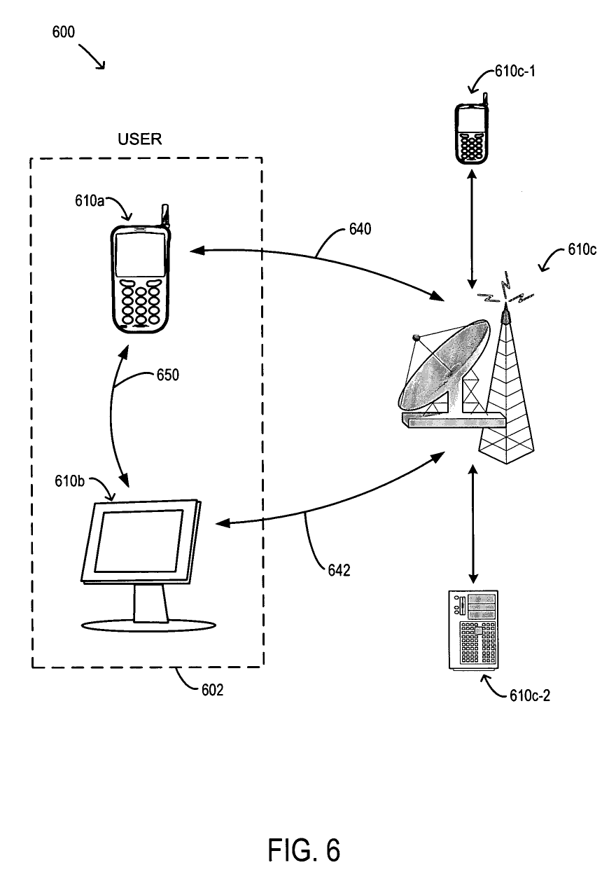

Turning now to FIG. 6, a diagram of an exemplary system 600 according to some embodiments is shown. The system 600 may, for example, be utilized to implement and/or perform the method 300 described herein and/or may be associated with the systems 100, 200, 400 described in conjunction with any of FIG. 1, FIG. 2, and/or FIG. 4. In some embodiments, fewer or more components than are shown in FIG. 6 may be included in the system 600. According to some embodiments, different types, layouts, quantities, and configurations of systems may be used.

In some embodiments, the system 600 may include a user 602. The user 602 may, for example, be associated with a first device 610a and/or a second device 610b. According to some embodiments, the first device 610a may be or include a cellular telephone, and/or the second device 610b may be or include a TV and/or other display device. The user 602 may utilize the cellular telephone 610a, for example, to communicate with a third device 610c. In some embodiments, the third device 610c may be or include a cellular network and/or cellular communication device (such as a cellular network tower) that may, for example, facilitate communication between the cellular telephone 610a of the user 602 and another cellular telephone 610c-1 (e.g., associated with another user). According to some embodiments, the third device 610c may be or include a broadcast communication device such as a radio and/or HDTV transmitter. The third device 610c may, for example, send broadcast information and/or media from a broadcast server 610c-2 to the cellular telephone 610a utilized by the user 602.

As an example, the user 602 may utilize the cellular telephone 610a to conduct a communication session 640 with the third device 610c. The user 602 may, for example, receive broadcast media such as sports scores and/or news from the third device 610c (e.g., such as a news server 610c-2) and/or the communication session 640 may be bi-directional (e.g., may be conducted between the cellular telephone 610a and another cellular telephone 610c-1). According to some embodiments, it may be desirable to transfer the communication session 640. In the case that the cellular telephone 610a runs low on battery power, enters and/or is about to enter an area of poor cellular reception, and/or otherwise becomes undesirable for conducting the communication session 640, the communication session 640 may, for example, be automatically transferred to the second device 610b (e.g., to establish the transferred communication session 642).

In some embodiments, the user 602 may specify, indicate, and/or otherwise define if and/or when the communication session 640 is to be transferred. According to some embodiments, the user 602 may also or alternatively specify and/or define that the communication session 640 is to be transferred to the second device 610b. In some embodiments, the second device 610b may be automatically and/or otherwise determined. In the case that the user 602 is conducting the communication session 640 utilizing the cellular telephone 610a, for example, the user 602 may provide an indication (e.g., a menu selection, a button press, and/or a voice command) and/or the cellular telephone 610a may determine that the communication session 640 is desired to be transferred. The cellular telephone 610a may, for example, automatically determine that battery power and/or signal strength depletions warrant transferring the communication session 640.

According to some embodiments, the second device 610b may be automatically detected by the cellular telephone 610a. Any or all devices associated with the user 602 may, for example, include device network communication modules that allow automatic detection, identification, and/or communication between the devices. The cellular telephone 610a may, according to some embodiments, communicate with the second device 610b via a device network path 650. The device network path may, for example, be established using Bluetooth® and/or other wireless communication protocols.

As an example, the user 602 may utilize the cellular telephone 610a to communicate with another cellular telephone 610c-1 (e.g., via the third device 610c). The communication session 640 may be conducted, for example, while the user 602 is traveling to work. Upon arriving in the office of the user 602, the cellular telephone 610a may automatically detect the presence of the second device 610b, such as the office computer of the user 602. Because it may not be desirable to use the cellular telephone 610a in the office, for example, the user 602 may make a menu selection on the cellular telephone 610a to indicate that the user 602 desires to transfer the communication session to the office computer 610b. In some embodiments, the user 602 may establish pre-defined conditions such as “when in the office, the office computer is the preferred communication device.” In the case that such a pre-defined condition is programmed into either or both of the cellular telephone 610a and the office computer 610b, for example, the communication session 640 may be automatically transferred without requiring input from the user 602 upon entering the office.

According to some embodiments, the transferred communication session 642 may be conducted in a different medium than the original communication session 640. While the original communication session 640 may be a voice call between the cellular telephone 610a and the other cellular telephone 610c-1, for example, the transferred communication session 642 may be a text-based IM session conducted between the office computer 610b and the other cellular telephone 610c-1. In some embodiments, such as in the case that the other cellular telephone 610c-1 does not support text-based messaging, the transferred communication session 642 may be conducted between the office computer 610b and a computer 610c-2 associated with the same entity (e.g., a second user) operating the other cellular telephone 610c-1.

For example, when the cellular telephone 610a transfers the communication session 640 to the office computer 610b (e.g., via the device network path 650), the cellular telephone 610a may provide the office computer 610b with information associated with the other cellular telephone 610c-1, the third device 610c, the computer 610c-2, and/or an associated entity. The cellular telephone 610a may, for example, provide the office computer 610b with an IP address associated with the computer 610c-2. In some embodiments, the cellular telephone 610a may have access to information relating various communication mediums and/or devices associated with another entity. According to some embodiments, the cellular telephone 610a may query the other cellular telephone 610c-1 to obtain and/or identify such information (e.g., an IP address of a text-enabled device associated with the other cellular telephone 610c-1).

In some embodiments, once it is determined that the communication session 640 is to be transferred, the cellular telephone 610a may send any appropriate, desirable, and/or necessary information regarding the communication session 640 to the office computer 610b. The information may be sent, for example, via the device network communication path 650. According to some embodiments, the office computer 610b may then determine how to establish the transferred communication session 642. The office computer 610b may, for example, lookup and/or otherwise determine the telephone number and/or IP address associated with the other cellular telephone 610c-1 and/or the computer 610c-2. In some embodiments, the office computer 610b may then initiate the transferred communication session 642 with the other cellular telephone 610c-1 and/or with the computer 610c-2.

According to some embodiments, the office computer 610b may then notify the cellular telephone 610a (e.g., via the device network communication path 650) that the transferred communication session 642 has been successfully established. In some embodiments, if errors occur in establishing the transferred communication session 642, the office computer 610b may also or alternatively notify the cellular telephone 610a of such problems. In the case that the transferred communication session 642 is successfully established, the cellular telephone 610a may, according to some embodiments, terminate the original communication session 640. Once the user 602 begins communicating with the desired third device 610c, for example, the voice call 640 may no longer be necessary and/or desirable. In such a manner, for example, the communication session 640 may be continued in a substantially uninterrupted manner even when the user 602 desires to switch devices 610a-d and/or communication mediums.

As another example, the user 602 may utilize the cellular telephone 610a to receive text-based sports news, such as a simulcast broadcast of a sports game. The simulcast broadcast may, for example, comprise the communication session 640 between the cellular telephone 610a and the third device 610c, such as a broadcast server 610c-2. In some embodiments, the user 602 may be walking home, for example, and utilizing the cellular telephone 610a to monitor the progress of the sports game. In the case that the user 602 arrives home, the user 602 may desire to transfer the communication session 640 to another device within the home of the user 602. Upon entering the home, for example, the cellular telephone 610a may automatically detect (e.g., via the device network communication path 650) other devices within the home (e.g., coupled to a home network).

In some embodiments, the user 602 may command the cellular telephone 610a to transfer the communication session 640 to the TV 610b of the user 602. According to some embodiments, the cellular telephone 610a and/or the TV 610b may automatically determine that the communication session 640 is desired to be transferred. In the case that a communication session 640 is conducted in the home of the user 602, for example, the home network and/or any or all of the devices 610a-b associated with the user 602 may be programmed to determine one or more desired and/or preferred devices. The TV 610b may, according to some embodiments, be the preferred device for conducting communication sessions 640, 642 in the home of the user 602.

According to some embodiments, the cellular telephone 610a and/or the TV 610b may determine TV, cable, and/or satellite channel information corresponding to the text-based simulcast received by the cellular telephone 610a. The cellular telephone 610a and/or the TV 610b may, for example query the broadcast server 610c-2 to determine various stations, channels, and/or other addresses via which the sports game may be broadcast in various mediums. The TV 610b may, according to some embodiments, be automatically turned on and/or tuned to the appropriate channel or station for receiving the sports game broadcast from the broadcast server 610c-2 (e.g., the transferred communication session 642 may be established).

In some embodiments, once the TV 610b is tuned and/or activated to display the sports game, the simulcast communication session 640 on the cellular telephone 610a may be terminated. The TV 610b and/or home network may, for example, notify the cellular telephone 610a that the transferred communication session 642 has been established and that the original communication session 640 is no longer needed. In such a manner, for example, the user 602 may monitor the sports game in a substantially uninterrupted manner. Wherever the user 602 goes that is serviced by a device associated with the user 602, for example, the sports game may be monitored (e.g., via various mediums) in a substantially uninterrupted manner, without requiring substantial (or any) input from the user 602.

As another example, the user 602 may begin a download of a file from a computer server 610c-2, utilizing the PC 610b (and/or a PDA) associated with the first user 602. The download may, for example, comprise the communication session 642. The user 602 may, according to some embodiments, need to leave the PC 610b, yet may desire to continue the file download 642. In some embodiments, the user 602 may carry the cellular telephone 610a in a pocket. The user 602 may indicate to the PC 610b that the user 602 desires to leave while continuing the file download 642. In some embodiments, the PC 610b may search for and/or otherwise identify any or all other devices associated with the user 602 that are available (e.g., activated, turned-on, and/or in proximity). The cellular telephone 610a may, for example, be Bluetooth®-enabled and may accordingly periodically transmit an identification and/or detection signal that may be detected and/or identified by the PC 610b.

The PC 610b, upon detection of the cellular telephone 610a, for example, may transmit information associated with the file download 642 to the cellular telephone 610a. The PC 610b may provide, for example, the IP address of the computer server 610c-2, an identification of the download session, a status of the download session, and/or the portions of the file already downloaded by the PC 610b. The PC 610b may, for example, transfer the partially downloaded file to the cellular telephone 610a, along with an identifier of the download session (e.g., a unique identifier and/or other key). The PC 610b may also or alternatively suspend the original file download 642.

The cellular telephone 610a may then, for example, contact the computer server 610c-2 to continue the transferred file download 640. In some embodiments, the cellular telephone 610a may provide the download session identifier to the computer server 610c-2 so that the computer server 610c-2 may, for example, identify where the PC 610b left off in downloading the file. The cellular telephone 610a may, such as in the case that the PC 610b provides the cellular telephone 610a with the partially downloaded file, append newly downloaded portions of the file to continue the transferred file download 640. According to some embodiments, any or all of the processes involved in transferring the file download 640, 642 may occur without substantial involvement from the user 602. Once the user 602 indicates that the file download 642 is desired to be transferred, for example, the cellular telephone 610a may automatically be activated, configured, provided with information (e.g., including portions of the downloaded file), and/or otherwise may continue the file download 640 without requiring input from the user 602. In such a manner, for example, wherever the user 602 goes that is serviced by a device associated with the user 602, the file download 640, 642 may automatically be continued without substantial interruption (e.g., until the download is completed).

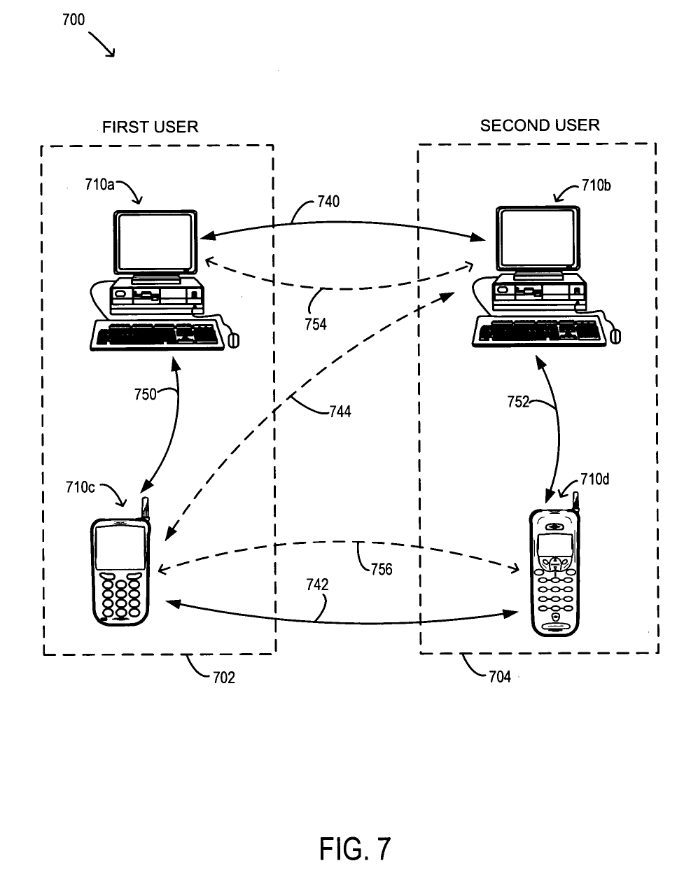

Turning now to FIG. 7, a diagram of an exemplary system 700 according to some embodiments is shown. The system 700 may, for example, be utilized to implement and/or perform the method 500 described herein and/or may be associated with the systems 100, 200, 400 described in conjunction with any of FIG. 1, FIG. 2, and/or FIG. 4. In some embodiments, fewer or more components than are shown in FIG. 7 may be included in the system 700. According to some embodiments, different types, layouts, quantities, and configurations of systems may be used.

The system 700 may include, for example, one or more users (e.g., first and second users 702, 704), one or more communication devices 710a-d, one or more communication sessions 740, 742, 744, and/or one or more device network communication paths 750, 752, 754, 756. In some embodiments, the communication devices 710a-d may be associated with one or more of the users 702, 704. As shown in FIG. 7, for example, the first and third communication devices 710a, 710c may be associated with the first user 702 and/or the second and fourth communication devices 710b, 710d may be associated with the second user 704. According to some embodiments, fewer or more communication devices 710a-d and/or users 702, 704 may be included in the system 700.

In some embodiments, the first user 702 may conduct a communication session 740 with the second user 704. The first user 702 may utilize the first communication device 710a, which may be or include a first PC device. The second user 704 may, according to some embodiments, utilize the second communication device 710b, which may be or include a second PC device. The communication session 740 may, for example, be a text-based IM session between the two PC devices 710a, 710b. In some embodiments, either or both of the users 702, 704 may desire to transfer the communication session 740 to another device and/or medium.

For example, the first user 702 may desire to move away from and/or otherwise discontinue use of the first PC device 710a, while not interrupting the communication session 740 with the second user 704. Upon receiving and/or determining an indication associated with the desire to transfer the IM session 740, in some embodiments, the first PC device 710a may search for, detect, and/or otherwise identify the third communication device 710c associated with the first user 702. The third communication device 710c may, for example, be a cellular telephone carried by the first user 702 and/or otherwise located within proximity to the first PC device 710a (e.g., within an operational wireless range of a home network that the first PC device 710a may be connected to).

In some embodiments, the first PC device 710a may transfer and/or otherwise provide information about the communication session 740 (e.g., the IM session) to the cellular telephone 710c. The information may be provided, for example, via a device network communication path 750. In some embodiments, the device network communication path 750 may be or include a Bluetooth®, wireless, and/or wired communication path between the first and third communication devices 710a, 710c. The device network communication path 750 may, for example, be a local wireless network (such as a Bluetooth® network) established between any or all devices 710a, 710c associated with the first user 702.

The information provided to the cellular telephone 710c may include, according to some embodiments, address and/or other identifier information associated with the second PC device 710b and/or the fourth communication device 710d associated with the second user 704. For example, the first PC device 710a may provide the telephone number of the fourth communication device 710d, which may be a wireless telephone. In some embodiments, the first PC device 710a may provide information that facilitates the identification and/or contact of the wireless telephone 710d. The first PC device 710a may, for example, send the IP address of the second PC device 710b to the cellular telephone 710c. The cellular telephone 710c may utilize the IP address to contact the second PC device 710b (e.g., to establish a transferred communication session 744 and/or to identify or locate the wireless telephone 710d) and/or to lookup (e.g., in a database and/or file) the telephone number of the wireless telephone 710d. The cellular telephone 710c may then, for example, utilize the determined telephone number to establish a transferred voice communication session 742 with the wireless telephone 710d.

According to some embodiments, the cellular telephone 710c may notify the first PC device 710a in the case that the transferred communication session 742 is established. The first PC device 710a may then, for example, terminate the original IM session 740. In some embodiments, the transferred communication session 742 may be conducted in a medium other than and/or in addition to the medium used to conduct the original communication session 740. The original text-based IM session 740 may, for example, be transferred to the cellular telephone 710c to be conducted as a voice call 742 with the wireless telephone 710d. In some embodiments, the voice call 742 may also or alternatively include text, images, and/or other mediums (e.g., a hybrid medium communication session).

In some embodiments, the communication session 740 (e.g., the IM session) may also or alternatively be transferred on the other side of the communication session 740. According to some embodiments for example, the devices 710b, 710d associated with the second user 704 may also utilize a device network communication path 752 to facilitate and/or conduct the transfer of the IM session 740. The first PC device 710a may, for example, notify the second PC device 710b of the desire to transfer the IM session 740. The notification may be provided, for example, as part of the communication session 740 and/or utilizing the device network communication path 754. The first PC device 710a may, for example, send communication session 740 information to the second PC device 710b via a Bluetooth® connection 754, during and/or separate from the IM session 740.

In some embodiments, the second PC device 710b may automatically locate, detect, and/or otherwise identify the wireless telephone 710d. The second PC device 710b may then, for example, set the wireless telephone 710d to automatically accept and/or activate upon receipt of a communication attempt from the cellular telephone 710c. In some embodiments, the wireless telephone 710d may also or alternatively establish communications (e.g., via the transferred communication session 742 and/or via the device network communication path 756) with the cellular telephone 710c. In other words, the second user 704 may not be required to substantially be involved in the transfer of the IM session 740 to the voice session 742.

According to some embodiments, the device network communication paths 750, 752, 754, 756 associated with the users 702, 704 may be compatible, interconnected, and/or may be the same type, configuration, and/or portion of a network. Any or all of the communication devices 710a-d may, for example, detect, identify, and/or communicate with one another. In some embodiments, the device network communication paths 750, 752, 754, 756 between the devices may be separate and/or different than the communication mediums and/or methods otherwise utilized by the devices 710a-d. The PC devices 710a-b may be capable of communicating via an IP network, for example, and may further include Bluetooth® modules allowing device detection and/or communication that may occur simultaneously but separately from any IP communications (e.g., occurring in the background and/or transparent to the users 702, 704).

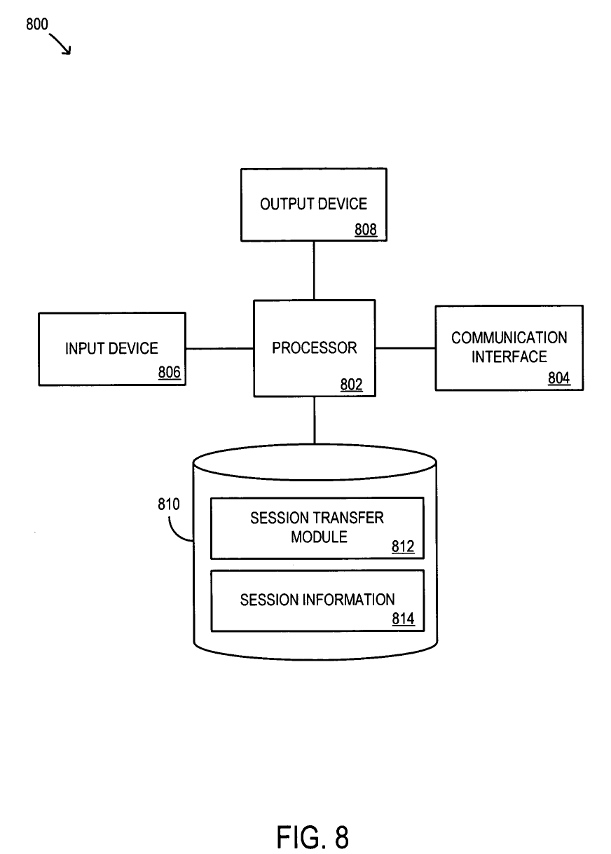

Turning now to FIG. 8, a diagram of an exemplary system 800 according to some embodiments is shown. The system 800 may, for example, be utilized to implement and/or perform the methods 300, 500 described herein and/or may be associated with the systems 100, 200, 400, 600, 700 described in conjunction with any of FIG. 1, FIG. 2, FIG. 4, FIG. 6, and/or FIG. 7. In some embodiments, fewer or more components than are shown in FIG. 8 may be included in the system 800. According to some embodiments, different types, layouts, quantities, and configurations of systems may be used.

In some embodiments, the system 800 may be or include a computer such as a PC, a computer server, and/or a notebook computer. According to some embodiments, the system 800 may be any type or configuration of communication device such as the first communication devices 110a, 210a, 410a, 610a, 710a described herein. The system 800 may include, for example, one or more processors 802, which may be any type or configuration of processor, microprocessor, and/or micro-engine that is or becomes known or available. In some embodiments, the system 800 may also or alternatively include one or more communication interfaces 804, one or more input devices 806, one or more output devices 808, and/or a memory device 810, all and/or any of which may be in communication with the processor 802. The memory device 810 may store, for example, a session transfer module 812 and/or session information 814.

The communication interface 804 may be or include any type and/or configuration of communication device that is or becomes known or available. In some embodiments, the communication device 804 may allow the system 800 (and/or the processor 802) to communicate with, for example, one or more communication devices (e.g., communication devices 110, 210, 410, 610, 710). According to some embodiments, the communication interface 804 may be or include a Network Interface Card (NIC) such as an Intel® PRO/1000 MT Desktop Adaptor that operates in accordance with the Fast Ethernet LAN transmission standard 802.3-2002® published by the Institute of Electrical and Electronics Engineers (IEEE), or an Intel(& PRO/Wireless 2225BG Network Connection that operates in accordance with the Wireless LAN transmission standard 802.11 B/G-1999/2003® published by the IEEE.

The input device 806 may be or include one or more conventional devices such as a keyboard, a mouse, a trackball, etc. The input device 806 may be utilized, for example, by an operator and/or system user to interface with the session transfer module 812 (e.g., executed by the processor 802), and/or to facilitate the management, establishment, and/or transfer of communication sessions (e.g., in a substantially uninterrupted manner) in accordance with embodiments described herein. The output device 808 may be or include any type of output device that is or becomes known or practicable, including, but not limited to, a printer, a Cathode Ray Tube (CRT) display device, a Liquid Crystal Display (LCD) device, and/or a Light-Emitting Diode (LED) display device.

The memory device 810 may be or include, according to some embodiments, one or more magnetic storage devices, such as hard disks, one or more optical storage devices, and/or solid state storage. The memory device 810 may store, for example, the session transfer module 812 and/or the session information 814. In some embodiments, the session transfer module 812 may store instructions that cause the processor 802 to operate in accordance with embodiments described herein. The session transfer module 812 may, for example, automatically detect, identify, and/or communicate with other communication devices (e.g., via a device network such as Bluetooth®) and/or may automatically transfer communication sessions from one device and/or medium to another (e.g., through the communication interface 804).

According to some embodiments, the session transfer module 812 may automatically detect another communication device (e.g., at 302 and/or 502), create a network connection with the automatically detected device (e.g., at 304 and/or 504), conduct a communication session (e.g., at 306 and/or 506), and/or transfer the communication session to the automatically detected communication device (e.g., at 308 and/or 510). The session transfer module 812 may, for example, store instructions and/or conditional programming that are executed and/or processed by the processor 802 to implement the methods 300, 500 (and/or any portions thereof) described herein.

According to some embodiments, the session transfer module 812 may include an interface such as a GUI that may be utilized by a user of the system 800 to conduct, control, manage, and/or interact with embodiments as described herein. The session transfer module 812 may also or alternatively include a device communication application that allows the system 800 to automatically detect and/or communicate with other communication devices and/or systems. In some embodiments, the session transfer module 812 may utilize the session information 814 to facilitate communication between devices and/or to facilitate or conduct communication session transfers.

For example, the system 800 may receive the session information 814 (e.g., via the communication interface 804 and/or the device communication application of the session transfer module 812) regarding a communication session conducted at and/or between one or more other communication devices and/or systems. The system 800 and/or the session transfer module 812 may, according to some embodiments, utilize the session information 814 to establish a transferred communication session. The session information 814 may include, for example, information associated with communication device addresses, identifiers, configurations, and/or specifications, information associated with communication session parameters, statistics, and/or other metrics, and/or information associated with various users and/or entities.

In some embodiments, the session information 814 may include a cross-reference of various communication device addresses and/or identifiers that are associated with a particular user. The cross-reference information may be used, for example, by the session transfer module 812 to transfer a communication session from one medium and/or communication device to another medium and/or communication device. According to some embodiments, such as in the case that the system 800 conducts a communication session, information associated with the communication session may be stored in the memory 810 as the session information 814. The session information 814 may then, for example, be provided to other communication devices and/or systems to facilitate transfer of the communication session to one or more of those devices. The system 800 and/or the session transfer module 812 may, according to some embodiments, allow communication sessions to be continue without substantial interruption, even when being transferred between devices and/or mediums, without requiring substantial and/or any user involvement.

Although some embodiments and attendant examples provided herein describe communication session transfers between communication devices, it should be understood that communication sessions may also or alternatively be transferred in a substantially uninterrupted manner between communication mediums. A voice communication session between two telephone devices may, for example, be transferred and/or converted to a text-based IM session (or vise versa) between the same two telephone devices. In some embodiments, transfers between both devices and mediums may also or alternatively be conducted without substantial user involvement.

The several embodiments described herein are solely for the purpose of illustration. Those skilled in the art will note that various substitutions may be made to those embodiments described herein without departing from the spirit and scope of the present invention. Those skilled in the art will also recognize from this description that other embodiments may be practiced with modifications and alterations limited only by the claims.

What is claimed is:

1. A method, comprising:
automatically detecting, at a first device associated with a first user, a second device associated with the first user; and
creating, at the first device associated with the first user, a network connection between the first and second devices associated with the first user, wherein the first device associated with the first user is to operate in a first medium and the second device associated with the first user is to operate in a second medium.

2. The method of claim 1, further comprising:
conducting a communication session at the first device associated with the first user, wherein the communication session at the first device associated with the first user is conducted in the first medium.

3. The method of claim 2, further comprising:
transferring the communication session to the second device associated with the first user, wherein the communication session at the second device associated with the first user is conducted in the second medium.

4. The method of claim 3, further comprising:
determining, by the first device associated with the first user, that the communication session is to be transferred.

5. The method of claim 4, wherein the determining comprises:
identifying, at least in part by the first device associated with the first user, a change in location of the first device associated with the user.

6. The method of claim 4, wherein the determining comprises:
receiving, at the first device associated with the first user, an indication associated with a desire to transfer the communication session.

7. The method of claim 6, wherein the indication is received from the first user.

8. The method of claim 6, wherein the indication is received from a third device involved in the communication session.

9. The method of claim 3, wherein the transferring comprises:
providing, by the first device associated with the first user, information associated with the communication session.

10. The method of claim 9, wherein the information associated with the communication session comprises information associated with a third device involved in the communication session.

11. The method of claim 2, wherein the communication session comprises a broadcast transmitted from a third device.

12. The method of claim 2, wherein the communication session conducted by the first device associated with the first user is conducted between the first device associated with the first user and a third device associated with a second user.

13. The method of claim 12, further comprising:
automatically detecting, at the third device associated with the second user, a fourth device associated with the second user; and
creating, at the third device associated with the second user, a network connection between the third and fourth devices associated with the second user, wherein the third device associated with the second user is to operate in the first medium and the fourth device associated with the second user is to operate in the second medium.

14. The method of claim 13, further comprising:
transferring, by the third device associated with the second user, the communication session to the fourth device associated with the second user, wherein the communication session at the fourth device associated with the second user is conducted in the second medium.

15. The method of claim 14, wherein the transferring by the third device associated with the second user comprises:
receiving, by the third device associated with the second user, an indication from the first device associated with the first user, wherein the indication is associated with transferring the communication session to at least one of the second device associated with the first user or the fourth device associated with the second user.

16. A method, comprising:
automatically detecting, at a first device associated with a first user, a second device associated with the first user;
creating, at the first device associated with the first user, a network connection between the first and second devices associated with the first user, wherein the first device associated with the first user is to operate in a first medium and the second device associated with the first user is to operate in a second medium; and
conducting a communication session at the first device associated with the first user, wherein the communication session at the first device associated with the first user is conducted in the first medium and wherein the communication session is conducted with a third device associated with a second user, wherein the third device associated with the second user is to operate in the first medium.

17. The method of claim 16, further comprising:
transferring the communication session to the second device associated with the first user, wherein the communication session at the second device associated with the first user is conducted in the second medium.

18. The method of claim 16, further comprising:
transferring the communication session to a fourth device associated with the second user, wherein the communication session at the fourth device associated with the second user is conducted in the second medium.

19. The method of claim 16, further comprising:
creating, at the third device associated with the second user, a network connection between the third device associated with the second user and a fourth device associated with the second user, wherein the fourth device associated with the second user is to operate in the second medium.

20. A system, comprising:
a memory configured to store instructions;
a communication port; and
a processor coupled to the memory and the communication port, the processor being configured to execute the stored instructions to:
automatically detect, at a first device associated with a first user, a second device associated with the first user; and
create, at the first device associated with the first user, a network connection between the first and second devices associated with the first user, wherein the first device associated with the first user is to operate in a first medium and the second device associated with the first user is to operate in a second medium.
